(19) United States
(12) Patent Application Publication
(10) Pub. No.: US 2026/0205978 A1
(43) Pub. Date: Jul. 16, 2026

(54) NETWORK SLICE SERVICE OVER RELAYS IN COMMUNICATION NETWORKS

(71) Applicant: T-MOBILE INNOVATIONS LLC, Overland Park, KS (US)

(72) Inventor: Wafik Abdelshahid, Kenmore, WA (US)

(21) Appl. No.: 19/024,469

(22) Filed: Jan. 16, 2025

(51) Int. Cl. H04W 60/04; H04W 48/18; H04W 64/00; H04W 72/512

(52) U.S. Cl. CPC H04W 60/04; H04W 48/18; H04W 64/003; H04W 72/512

(57) ABSTRACT

Various embodiments include a system that comprises a relay, a network controller, and a user plane in a communication network. The relay registers with the network controller. The network controller indicates available network slices to the relay. The relay indicates the available network slices to a user device attached to the relay. The network controller receives a registration request from the user device for service on the communication network that includes a session request and that indicates a selected network slice of the available network slices indicated by the relay. The network controller registers the user device on the communication network. The network controller directs a user plane of the network slice to serve the user device. The user plane exchanges data with the user device over the relay.

### TECHNICAL FIELD

Various embodiments of the present technology relate to network slicing, and more specifically, to serving network slices to user devices connected to a communication network over a relay.

### BACKGROUND

Wireless communication networks provide wireless data services to wireless user devices. Exemplary wireless data services include voice calling, video calling, internet-access, media-streaming, online gaming, social-networking, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

Wireless communication networks implement network slicing to serve wireless user devices. A network slice is a type of network partition that groups a set of RAN and core network resources that have capabilities to provide one or more service types. Network slices may be configured to provide low-latency services, media streaming services, Internet-of-Things (IoT) services, and the like. Exemplary slice types include Ultra-Reliable Low Latency Communication (URLLC), Enhanced Mobile Broadband (eMBB), Massive Machine Type Communications (mMTC), Vehicle-to-Everything (V2X), Fixed Wireless Access (FWA), and private. By implementing network slicing, wireless communication networks optimize the computing and radio resources for specific service types thereby enhancing the overall user experience.

To extend the geographic range of the wireless data services, the wireless communication networks deploy wireless relays along with the wireless access nodes. The wireless relays have small wireless access nodes that serve a relatively small number of wireless user devices at the network edge. The wireless relays also have wireless user-like devices that are wirelessly served by the wireless access nodes or other wireless relays. Thus, the wireless relays are typically connected to the network cores over both wireless and wireline backhaul links. When user devices attach to the wireless communication network over a wireless relay, every user device attached to the relay is assigned to the same network slice, typically the network slice used by the relay itself. Different user devices comprise different capabilities and different session requirements. Assigning user devices attached to a wireless relay that have different capabilities and different session requirements to the same network slice degrades the overall user experience.

### OVERVIEW

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for network slicing. Some embodiments comprise a method. The method comprises registering, by a relay, with a network controller in a communication network over an access network. The method further comprises indicating, by the network controller, available network slices to the relay over the access network. The method further comprises indicating, by the relay, the available network slices to a user device attached to the relay. The method further comprises receiving, by the network controller, a registration request from the user device for service on the communication network that includes a session request and that indicates a selected network slice of the available network slices indicated by the relay. The method further comprises registering, by the network controller, the user device for the service on the communication network. The method further comprises directing, by the network controller, a user plane in the communication network and of the selected network slice to serve the user device. The method further comprises exchanging, by the user plane, user data with the user device over the access network and the relay.

Some embodiments comprise a system. The system comprises a relay, a network controller, and a user plane in a communication network. The relay registers with a network controller in a communication network over an access network. The network controller indicates available network slices to the relay over the access network. The relay indicates the available network slices to a user device attached to the relay. The network controller receives a registration request from the user device for service on the communication network that includes a session request and that indicates a selected network slice of the available network slices indicated by the relay. The network controller registers the user device for the service on the communication network. The network controller directs a user plane in the communication network and of the network slice to serve the user device. The user plane exchanges user data with the user device over the access network and the relay.

Some embodiments comprise one or more non-transitory computer readable storage media having program instructions stored thereon. When executed by a computing system, the program instructions direct the computing system to perform operations. The operations comprise directing a radio in a wireless relay to transfer a registration request to a network controller in a communication network over an access network. The network controller registers the relay with the communication network. The operations further comprise controlling the radio to receive a registration accept message and a User Equipment Route Selection Policy (URSP) container from the network controller over the access network. The URSP container indicates slice Identifiers (IDs) of available network slices on the communication network. The operations further comprise controlling the radio to receive an attachment request from a user device. The operations further comprise approving the attachment request from the user device. The operations further comprise directing the radio to transfer the URSP container to the user device. The user device selects one or more network slices based on the slice IDs indicated in the URSP container.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an example of a communication network to serve network slices to user devices over a relay.

FIG. 2 illustrates a first exemplary operation of the communication network to serve network slices to user devices over a relay.

FIG. 3 illustrates a second exemplary operation of the communication network to serve network slices to user devices over a relay.

FIG. 4 illustrates a third exemplary operation of the communication network to serve network slices to user devices over a relay.

FIG. 5 illustrates an example of a Fifth Generation (5G) communication network to serve network slices to User Equipment (UEs) over a 5G relay.

FIG. 6 illustrates an example of a 5G UE in the 5G communication network to serve network slices to UEs over a 5G relay.

FIG. 7 illustrates an example of a 5G relay in the 5G communication network to serve network slices to UEs over a 5G relay.

FIG. 8 illustrates an example of a 5G Radio Access Network (RAN) in the 5G communication network to serve network slices to UEs over a 5G relay.

FIG. 9 illustrates an example of a 5G data center in the 5G communication network to serve network slices to UEs over a 5G relay.

FIG. 10 further illustrates the 5G data center in the 5G communication network to serve network slices to UEs over a 5G relay.

FIG. 11 illustrates an exemplary operation of the 5G communication network to serve network slices to the UEs over the 5G relay.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

In a conventional wireless communication network, wireless relays are deployed to extend the range of wireless communication networks. The wireless relays have small wireless access nodes that serve a smaller number of wireless user devices at the network edge. In contrast, wireless access nodes like eNodeBs or gNodeBs are larger and serve a larger numbers of wireless user devices. The wireless relays also have wireless user-like devices that are wirelessly served by the wireless access nodes or other wireless relays. For example, a user may deploy a relay in their residence to enhance the wireless service in their residence.

A network slice is a type of network partition that groups a set of Radio Access Network (RAN) and core network resources that have capabilities to provide one or more service types. When user devices attach to the communication network over a traditional access node (e.g., a gNodeB), the user device may be assigned to a network slice based on the device’s subscription on the network, the device’s capabilities, and the device’s session requirements. Typically, user devices are assigned to network slices with capabilities that align with the capabilities and session requirements of the user devices. Like user devices, wireless relays may be assigned to a network slice when the relay attaches to the network. However, when user devices attach to the communication network over a relay, the user devices are assigned to the network slice of the relay. The capabilities, session requirements, and subscriptions of different user devices vary. The capabilities of the relay’s network slice may not be optimized for every device attached to the relay. This misalignment degrades the overall user experience.

To overcome the above-described problems in conventional wireless communication networks, various embodiments of the present technology relate to serving multiple network slice types to user devices over a relay. In some examples, a relay attaches and registers with a communication network. The communication network indicates, to the relay, the network slices available at the relay. When user devices attach to the relay, the relay exposes the available network slices to the user devices. The user devices select one or more of the available network slices based on their individual requirements and capabilities. The user devices register with the network over the relay to indicate their respective slice selections to the communication network. The communication serves the user devices on their selected slices over the relay. By serving multiple slice types to multiple user devices over a single relay, the communication network tailors service to relay connected user devices thereby improving the overall user experience when compared to conventional communication networks. Now referring to the Figures.

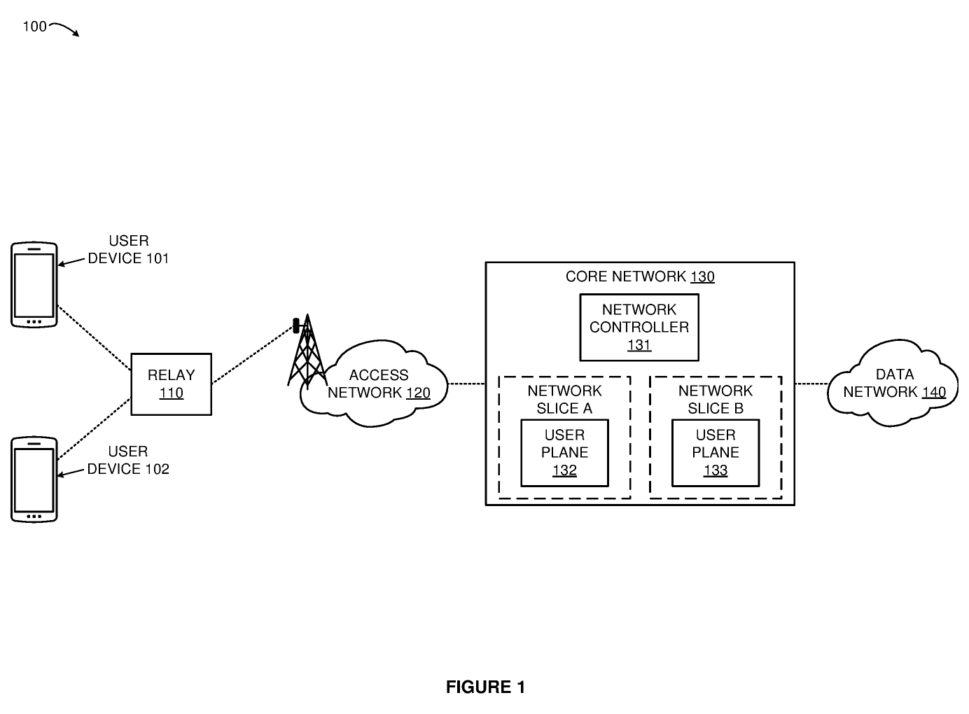

FIG. 1 illustrates communication network 100 to serve network slices to user devices over a relay. Communication network 100 provides services like media-streaming, media-broadcasting, internet-access, voice/video calling, text messaging, online gaming, social media, machine communications, remote device control, or some other wireless communications product. Communication network 100 comprises user device 101, user device 102, relay 110, access network 120 that is an example of a RAN, core network 130, and data network 140. Core network 130 comprises network controller 131, user plane 132, and user plane 133. As illustrated in FIG. 1, user plane 132 may be used to form network slice A and user plane 133 may be used to form network slice B. In other examples, communication network 100 may comprise additional or different elements than those illustrated in FIG. 1.

Various examples of network operation and configuration are described herein. In some examples, relay 110 attaches to access network 120 and transfers a registration request to network controller 131 to register with communication network 100. While illustrated as attaching to access network 120 over a wireless link, relay 110 may attach to access network 120 over a wired communication link. Network controller 131 registers relay 110 and transfers a registration accept message to relay 110 that indicates the available network slices over relay 110. For example, relay 110’s registration request may include location information for relay 110 (e.g., the Tracking Area Identifier (TAI) of access network 120) and network controller 131 may determine network slices A and B are available over relay 110 based on the location information. Relay 110 stores the available slice indication in memory.

User device 101 attaches to relay 110. User device 101 may connect via a wired or wireless connection to relay 110. In response to the attachment, relay 110 transfers the available slice indication to user device 101. User device 101 selects one or more of the available network slices based on the available slice indication. For example, user device 101 may compare its device capabilities and session requirements to the capabilities of the available network slices and select one or more of the network slices based on the comparison. User device 101 generates and transfers a registration request to network controller 131 to register for service on communication network 100 over relay 110 and access network 120. The registration request includes a session request for the selected network slice(s). Network controller 131 registers user device 101 for service on communication network 100. Network controller 131 directs user plane 132 and/or user plane 133 to serve user device 101 based on user device 101’s slice selection. For example, if user device 101 requested a data session on network slice A, network controller 131 would direct user plane 132 to serve user device 101. Network controller 131 generates and transfers a registration accept message to user device 101 over access network 120 and relay 110. Responsive to successful network registration, user device 101 begins its session(s) on the selected network slice(s) over relay 110. Accordingly, user device 101 may send data to and receive data from data network 140 via the selected network slice(s) over relay 110, access network 120, and one or more of user plane 132 or user plane 133. For example, in some instances, user device 101 may exchange user data with relay 110. Relay 110 may exchange the user data with user plane 132 and/or user plane 133 over access network 120. User plane 132 and/or user plane 133 may exchange the user data with data network 140.

Advantageously, communication network 100 effectively serves different network slices to user devices attached to the network over a relay. This efficiently tailors wireless/wireline service to relay connected user devices. Moreover, communication network 100 exposes the network slices available to the relay connected user devices upon attachment to the relay which allows the relay connected user device to select a network slice(s) during network registration further enhancing the user experience.

User devices 101 and 102 may comprise a phone, vehicle, drone, robot, computer, sensor, or another type of data appliance with wireless and/or wireline communication circuitry. User devices 101 and 102, relay 110, and access network 120 may communicate over links using wireless/wireline technologies like Sixth Generation Radio (6GR), Fifth Generation New Radio (5GNR), Long Term Evolution (LTE), Institute of Electrical and Electronic Engineers (IEEE) 802.11 (WiFi), IEEE 802.3 (Ethernet), Low-Power Wide Area Network (LP-WAN), Bluetooth, and/or some other type of wireless and/or wireline networking protocol. The wireless technologies use electromagnetic frequencies in the low-band, mid-band, high-band, or some other portion of the electromagnetic spectrum. The wired connections comprise metallic links, glass fibers, and/or some other type of wired interface.

Relay 110 may comprise a Sixth Generation (6G) router, a Fifth Generation (5G) router, an LTE router, gNodeB, eNodeB, a relay User Equipment (UE), a wireless relay, a Wifi hotspot, an Ethernet relay, a Bluetooth relay, a fixed wireless access point, a vehicle, drone, robot, computer, phone, sensor, and the like. Although access network 120 is illustrated as comprising a tower, access network 120 may comprise another type of mounting structure (e.g., a building), or no mounting structure at all. Access network 120 may comprise a Sixth Generation (6G) Radio Access Network (RAN), Fifth Generation (5G) RAN, LTE RAN, gNodeB, eNodeB, Narrow Band Internet-of-Things (NB-IoT) access node, trusted non-Third Generation Partnership Project (3GPP) access node, untrusted non-3GPP access node, Low Power-Wide Area Network (LP-WAN) base station, wireless relay, WiFi hotspot, Bluetooth access node, Ethernet access node, and/or another type of wireless or wireline network transceiver. While illustrated as comprising a terrestrial system, access network 120 may comprise a non-terrestrial (e.g., satellite based) access network. Relay 110 exchanges network signaling and user data with access network 120. Access network 120 exchanges network signaling and user data with network functions clustered together into core network 130. Relay 110 is connected to access network 120 over one or more wired or wireless relay links. Access network 120 is connected to core network 130 over one or more backhaul data links. Relay 110, access network 120, and core network 130 may communicate via edge networks like internet backbone providers, edge computing systems, or another type of edge system to provide the relay and backhaul data and signaling links between relay 110, access network 120, and core network 130.

Access network 120 may comprise Radio Units (RUs), Distributed Units (DUs) and Centralized Units (CUs). The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to the network cores. The CUs handle higher wireless network layers like the Radio Resource Control (RRC), Service Data Adaption Protocol (SDAP), and Packet Data Convergence Protocol (PDCP). The CUs are coupled to network functions in core network 130.

Core network 130 is representative of computing systems that provide wireless data services to user devices 101 and 102 over relay 110 and access network 120. Exemplary computing systems comprise Network Function Virtualization Infrastructure (NFVI) systems, data centers, server farms, cloud computing networks, hybrid cloud networks, and the like. Core network 130 may comprise a 3GPP core network architecture like Sixth Generation Core (6GC), Fifth Generation Core (5GC), Evolved Packet Core (EPC), and/or another type of 3GPP core network architecture. Relay 110, access network 120, core network 130, and data network 140 communicate over various links that use metallic links, glass fibers, radio channels, or some other communication media. The links use 6GC, 5GC, EPC, Ethernet, Time Division Multiplex (TDM), Data Over Cable System Interface Specification (DOCSIS), Internet Protocol (IP), General Packet Radio Service Transfer Protocol (GTP), 6GR, 5GNR, LTE, WiFi, virtual switching, inter-processor communication, bus interfaces, and/or some other data communication protocols. The computing systems of core network 130 store and execute the network functions/entities to form network controller 131 and user planes 132 and 133. Network controller 131 may comprise control plane network functions like Access and Mobility Management Function (AMF), Session Management Function (SMF), Authentication Server Function (AUSF), Network Slice Selection Function (NSSF), Policy Control Function (PCF), Unified Data Management (UDM), and the like. User planes 132 and 133 comprise user plane network functions like User Plane Function (UPF) and the like.

Network slices A and B are representative of collections of network elements (e.g., UPFs, control plane network functions, access nodes, etc.) with capabilities to support different service types over access network 120 and relay 110. For example, network slice A may comprise low-latency capabilities to support low-latency data sessions while network slice B may comprise high-uplink bandwidth capabilities to support media broadcasting sessions. Exemplary network slice types include Enhanced Mobile Broadband (eMBB), Ultra-Reliable Low-Latency Communications (URLLC), Massive Machine-Type Communications (mMTC) slice, Vehicle To Everything (V2X), Fixed Wireless Access (FWA), private, and the like. While illustrated as composing user planes 132 and 133, portions of network slices A and B may reside in network controller 131, access network 120, relay 110, or in other locations within communication network 100.

Data network 140 comprises application servers, gateways, routers, Content Distribution Networks (CNDs) and/or other communication devices to participate in data sessions with user devices 101 and 102. For example, data network 140 may comprise an application server that hosts the server-side component of a user application executing on user device 101. Data network 140 may be representative of a public data network (e.g., the Internet) or a private data network (e.g., an enterprise network). Core network 130 and data network 140 may communicate via links provided by internet backbone providers, edge computing services, and/or other communication services that provide the data links between core network 130 and data network 140.

User devices 101 and 102, relay 110, and access network 120 comprise antennas, amplifiers, filters, modulation, analog/digital interfaces, microprocessors, software, memories, transceivers, bus circuitry, and the like. User devices 101 and 102, relay 110, access network 120, core network 130, and data network 140 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), Analog Processing Units (APUs), and/or the like. The memories comprise Random Access Memory (RAM), Solid State Drives (SSDs), Hard Disk Drives (HDDs), Non-Volatile Memory Express (NVMe) SSDs, and/or the like. The memories store software like operating systems, user applications, radio applications, and network functions. The microprocessors retrieve the software from the memories and execute the software to drive the operation of communication network 100 as described herein.

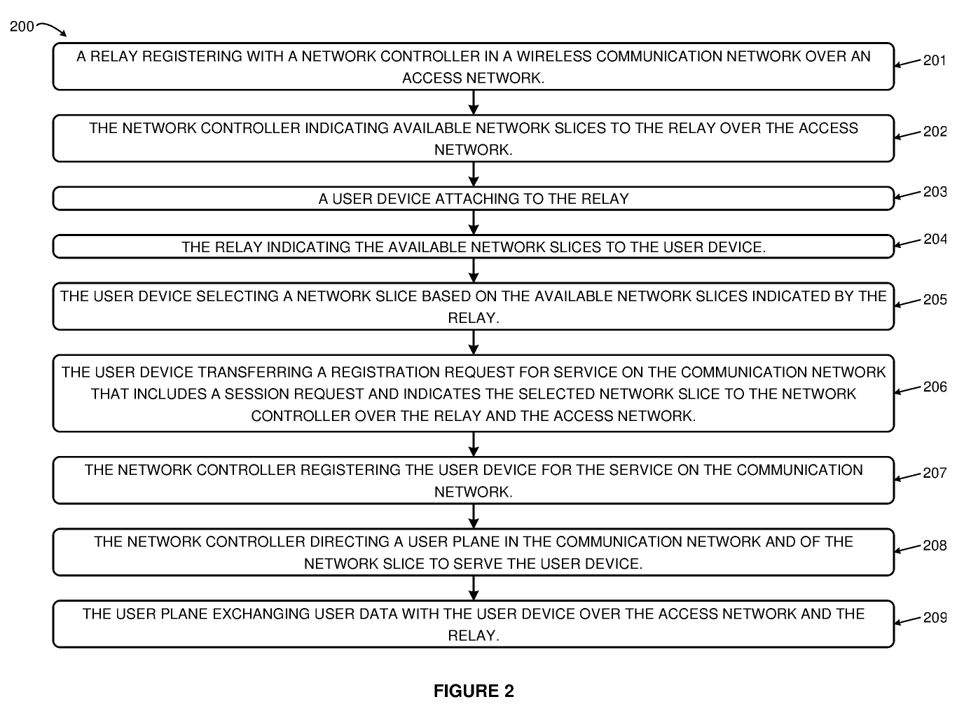

FIG. 2 illustrates process 200. Process 200 comprises an exemplary operation of communication network 100 to serve network slices to user devices over a relay. The operation may vary in other examples. The operations of process 200 comprise a relay registering with a network controller in a wireless communication network over an access network (step 201). The operations further comprise the network controller indicating available network slices to the relay over the access network (step 202). The operations further comprise a user device attaching to the relay (step 203). The operations further comprise the relay indicating the available network slices to the user device (step 204). The operations further comprise the user device selecting a network slice based on the available network slices indicated by the relay (step 205). The operations further comprise the user device transferring a registration request for service on the communication network that includes a session request and indicates the selected network slice to the network controller over the relay and the access network (step 206). The operations further comprise the network controller registering the user device for the service on the communication network (step 207). The operations further comprise the network controller directing a user plane in the communication network and of the network slice to serve the user device (step 208). The operations further comprise the user plane exchanging user data with the user device over the access network and the relay (step 209).

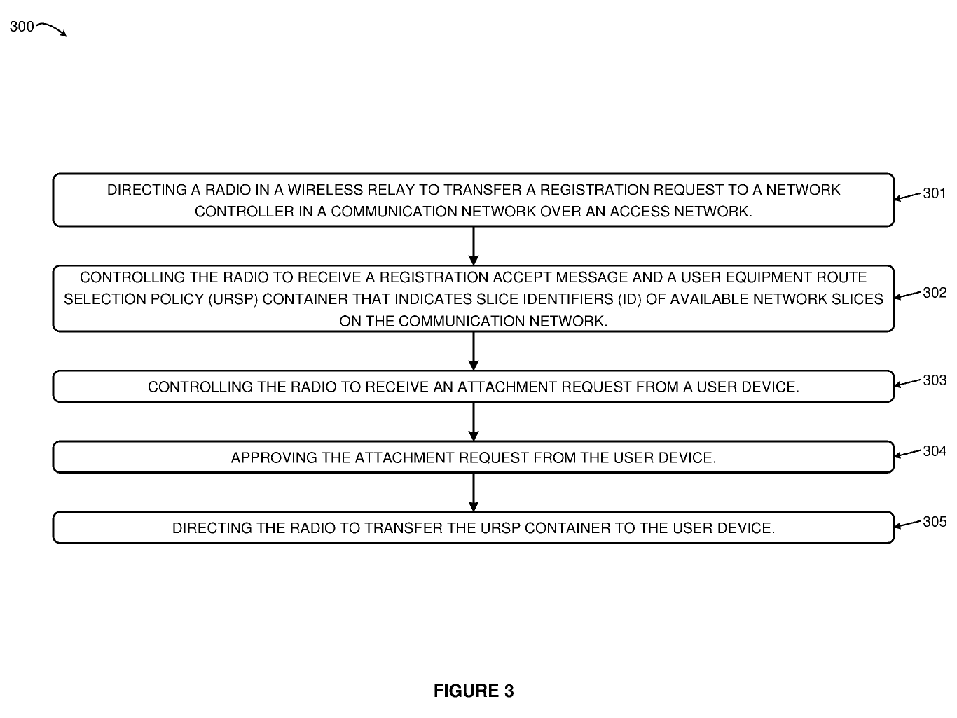

FIG. 3 illustrates process 300. Process 300 comprises an exemplary operation of communication network 100 to serve network slices to user devices over a relay. Process 300 comprises an example of process 200 illustrated in FIG. 2, however process 200 may differ. The operation may vary in other examples. The operations of process 300 comprise directing a radio in a wireless relay to transfer a registration request to a network controller in a communication network over an access network (step 301). The network controller registers the relay with the communication network. The operations further comprise controlling the radio to receive a registration accept message and a User Equipment Route Selection Policy (URSP) container from the network controller over the access network (step 302). The URSP container indicates slice Identifiers (IDs) of available network slices on the communication network. The operations further comprise controlling the radio to receive an attachment request from a user device (step 303). The operations further comprise approving the attachment request from the user device (step 304). The operations further comprise directing the radio to transfer the URSP container to the user device (step 305). The user device selects one or more network slices based on the slice IDs indicated in the URSP container.

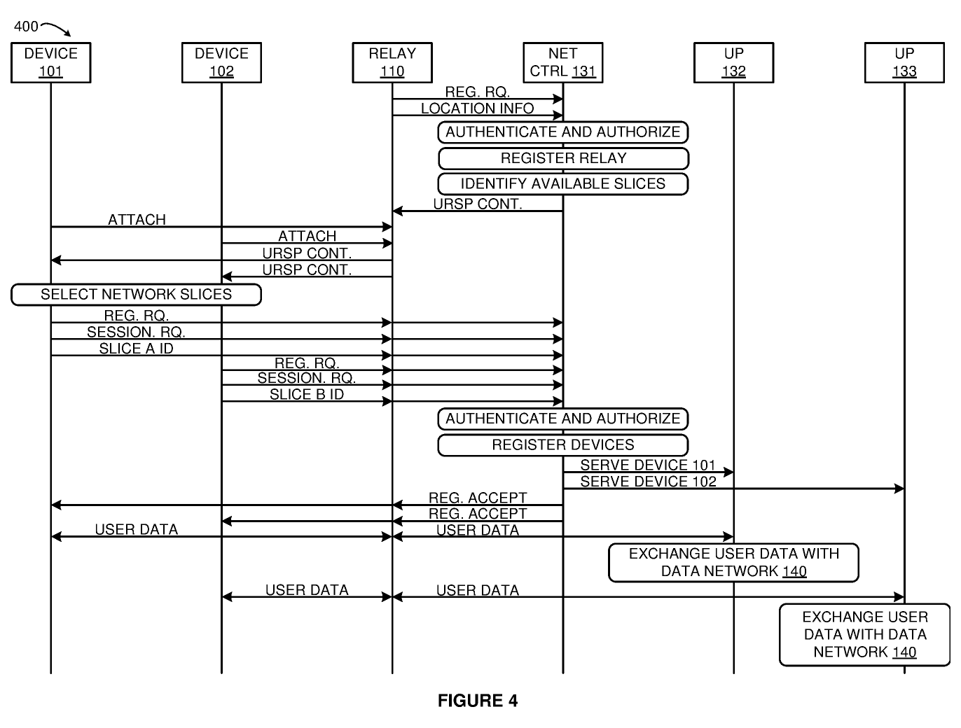

FIG. 4 illustrates process 400. Process 400 comprises an exemplary operation of wireless communication network 100 to serve network slices to user devices over a relay. Process 400 comprises an example of processes 200 and 300 illustrated in FIGS. 2 and 3, however processes 200 and 300 may differ. The operation may vary in other examples. In some examples, relay 110 attaches to access network 120. Relay 110 transfers a registration request to network controller (NET CTRL) 131 over access network 120. For example, processing circuitry in relay 110 may direct a radio in relay 110 to transfer the registration request for delivery to network controller 131. The registration request includes information like registration type, 5G Global Unique Temporary Identifier (5G-GUTI), TAI, device capabilities, Protocol Data Unit (PDU) session requests, device location information, and the like. Network controller 131 authenticates the identity of relay 110. Network controller 131 accesses a network data system that stores a subscriber profile for relay 110 to authorize relay 110 for service on communication network 100. Responsive to successful authentication and authorization, network controller 131 registers relay 110 with communication network 100.

Network controller 131 determines that relay 110 comprises a relay device. For example, relay 110’s registration request may include a device identifier or capability information. Alternatively, network controller 131 may determine relay 110 is a relay device by accessing the subscriber profile. In response, network controller 131 determines slices A and B are available over relay 110 based on the location information included in the registration request. Exemplary location information includes Global Positioning System (GPS) coordinates, access node TAI, and the like. Network controller 131 generates a URSP container (CONT.) that includes slice IDs for network slices A and B. Exemplary slice IDs include Single-Network Slice Selection Information (S-NSSAI) and the like. The URSP container also includes capabilities for each of the slice IDs. For example, slice A may comprise low-latency capabilities and slice B may comprise Guaranteed Bit Rate (GBR) capabilities. The URSP container may associate a low-latency network attribute with the slice ID of network slice A and associate a GBR network attribute with the slice ID of network slice B. Network controller 131 transfers a registration accept message and the URSP container to relay 110. Relay 110 stores the URSP container in memory. For example, processing circuitry in relay 110 may control the radio in relay 110 to receive the registration request and URSP container transferred by network controller 131.

Subsequently, user devices 101 and 102 transfer attachment requests to relay 110. For example, user devices 101 and 102 may wirelessly attach to relay 110 over a WiFi link and processing circuitry in relay 110 may control relay 110’s radio to receive the attachment requests. Relay 110 approves the requests and retrieves the URSP container from memory. Relay 110 provides the URSP container to user device 101 and user device 102. For example, processing circuitry in relay 110 may direct relay 110’s radio to wirelessly transfer the URSP container to user devices 101 and 102. User devices 101 and 102 compare their respective device capabilities and session requirements to the slice capabilities associated with each of the slice IDs indicated in the URSP container and select network slices based on the comparison. For example, user device 101 may comprise low-latency capabilities, may be initiating an online gaming session with low-latency requirements, and responsively select a slice ID in the URSP container associated with low-latency slice capabilities. In this example user device 101 selects network slice A and user device 102 selects network slice B. User device 101 generates a registration request to receive service on communication network 100. The registration request includes a session request and the slice ID for network slice A. User device 101 transfers the registration request to network controller 131 over relay 110 and access network 120. Similarly, user device 102 generates a registration request to receive service on communication network 100. The registration request of user device 102 includes a session request and the slice ID for network slice B. User device 102 transfers its registration request to network controller 131 over relay 110 and access network 120.

Network controller 131 receives the registration requests for user devices 101 and 102. Network controller 131 authenticates the identities of user devices 101 and 102. Network controller 131 accesses the network data system that stores subscriber profiles for user devices 101 and 102 to authorize user devices 101 and 102 for service on communication network 100. For example, network controller 131 may retrieve subscriber attributes from user devices 101 and 102’s subscriber profiles that authorize user devices 101 and 102 for service on network slices A and B. Responsive to successful authentication and authorization, network controller 131 registers user devices 101 and 102. Network controller 131 directs user plane (UP) 132 to serve user device 101 based on the slice ID for network slice A included in user device 101’s registration request. Likewise, network controller 131 directs user plane 133 to serve user device 102 based on the slice ID for network slice B included in user device 102’s registration request. User planes 132 and 133 acknowledge their respective service commands to network controller 131. Network controller 131 generates and transfers registration accept messages to user devices 101 and 102 over access network 120 and relay 110 that direct user devices 101 and 102 to begin their respective data sessions. User device 101 exchanges user data with user plane 132 in network slice A over relay 110 and access network 120. User plane 132 exchanges the user data with data network 140. User device 102 exchanges user data with user plane 133 in network slice B over relay 110 and access network 120. User plane 133 exchanges the user data with data network 140.

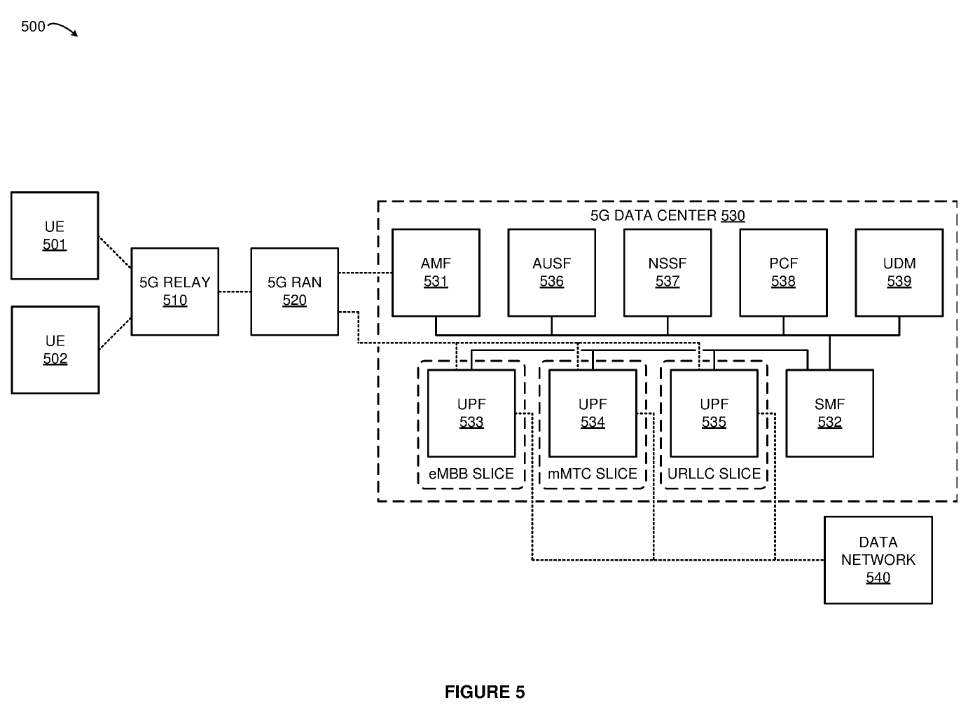

FIG. 5 illustrates 5G communication network 500 to serve network slices to User Equipment (UEs) over a 5G relay. 5G communication network 500 comprises an example of communication network 100 illustrated in FIG. 1, however network 100 may differ. 5G communication network 500 comprises 5G UE 501, 5G UE 502, 5G relay 510, 5G RAN 520, 5G data center 530, and data network 540. 5G data center 530 comprises AMF 531, SMF 532, UPFs 533-535, AUSF 536, NSSF 537, PCF 538, and UDM 539. Other network functions and network entities like Charging Function (CHF), Unified Data Registry (UDR), Home Subscriber Register (HLR), Home Subscriber Server (HSS), Network Repository Function (NRF), Short Message Service Function (SMSF), Network Exposure Function (NEF), Application Function (AF), Equipment Identity Register (EIR), and Session Communication Proxy (SCP) are typically present in 5G data center 530 but are omitted for clarity. 5G data center 530 comprises an eMBB slice, a mMTC slice, and a URLLC slice. UPF 533 forms the eMBB slice, UPF 534 forms the mMTC slice, and UPF 535 forms the URLLC slice. Although illustrated as only comprising UPFs, the eMBB slice, mMTC slice, and URLLC may comprise other network elements in 5G communication network 500. Moreover, some elements may be shared between different ones of the network slices. For example, the eMBB slice and the mMTC slice may both comprise SMF 532. It should be appreciated that 5G communication network 500 typically comprises many more network slices and slice types (e.g., V2X slices, FWA slices, private slices, etc.) and that three distinct slices are shown for clarity. In other examples, 5G communication network 500 may comprise different or additional elements than those illustrated in FIG. 5.

In some examples, 5G relay 510 comprises Wifi hotspot and 5G routing capabilities. 5G relay 510 wirelessly attaches to 5G RAN 520 over a 5GNR link. 5G relay 510 undergoes a Random Access Channel (RACH) procedure with 5G RAN 520 to establish a secure signaling channel. 5G relay 510 transfers a registration request to AMF 531 over 5G RAN 520. The registration request indicates a registration type, 5G-GUTI, TAI, NSSAI requests, UE capabilities, requests for PDU sessions, and the like. In response to the registration request, AMF 531 transfers a Non-Access Stratum (NAS) identity request to 5G relay 510 over a NAS signaling link between 5G relay 510 and AMF 531 that traverses 5G RAN 520. 5G relay 510 indicates its SUCI to AMF 531 over 5G RAN 520. AMF 531 transfers an authentication request to AUSF 536 to retrieve authentication vectors to authenticate 5G relay 510. The request comprises the SUCI for 5G relay 510. AUSF 536 indicates the SUCI and requests authentication vectors from UDM 539. UDM 539 accesses the subscriber profile for 5G relay 510 and derives the SUPI for 5G relay 510 based on the SUCI. UDM 539 returns the vectors and SUPI to AUSF 536. The authentication vectors comprise a random number, expected result, key selection criteria, and the like. AUSF 536 forwards the SUPI and authentication vectors to AMF 531. AMF 531 transfers an authentication challenge that comprises the random number and key selection criteria to 5G relay 510 over 5G RAN 520. 5G relay 510 hashes the random number with its secret key to generate an authentication result and indicates the authentication result to AMF 531 over 5G RAN 520. AMF 531 matches the expected result retrieved from AUSF 536 with the authentication result received from 5G relay 510 to authenticate 5G relay 510.

Responsive to the authentication, AMF 531 transfers a context registration request to UDM 539 that includes AMF ID, a supported feature list, a Permanent Equipment Identifier (PEI) for 5G relay 510, and the like. UDM 539 indicates successful UDM registration to AMF 531. In response, AMF 531 requests access and mobility subscription data, SMS selection subscription data, and UE context in SMF data from UDM 539. UDM 539 accesses the subscriber profile for 5G relay 510 and returns the requested data. The access and mobility subscription data may comprise a supported feature list for 5G relay 510 (e.g., relay capabilities, Quality of Service Class Indicator (QCI), Aggregate Maximum Bit Rate (AMBR), latency, voice/video calling, internet access, etc.), a General Public Subscription Identifier (GPSI) array, slice selection information, and the like. The SMF selection data may comprise a supported feature list and a list of allowed S-NSSAIs and associated information. The UE context in SMF data may comprise PDU session data and EPC interworking information. The access and mobility subscription data, SMS selection subscription data, and/or UE context in SMF data indicates 5G relay 510 comprises a relay device with sidelink capabilities (e.g., 5G router capabilities, Wifi hotspot, etc. capabilities). AMF 531 forms the context for 5G relay 510 using the retrieved information. The context defines the authorized services for 5G relay 510.

AMF 531 determines 5G relay 510 comprises sidelink capabilities (e.g., relay capabilities) based on the context for 5G relay 510. Alternatively, AMF 531 may determine 5G relay 510 comprises relay capabilities based on the capabilities component of the registration request received from 5G relay 510. In response, AMF 531 transfers a slice availability request that indicates the TAI of 5G relay 510 to NSSF 537 to determine the wireless network slices available over 5G relay 510. NSSF 537 determines that the eMBB slice, mMTC slice, and URLLC slice are available at 5G relay 510 based on the TAI. Typically, the network slices available at 5G relay 510 will be the same as the network slices available at the gNodeB in 5G RAN 520 that 5G relay 510 is attached to. For example, NSSF 537 may host a data structure that correlates network slice availability with TAIs in 5G communication network 500 and compare the TAI included in the slice availability request to the data structure to determine the network slices available at 5G relay 510. NSSF 537 transfers a slice availability response that includes the S-NSSAIs for the eMBB slice, mMTC slice, and the URLLC slice.

AMF 531 transfers a policy creation request to PCF 538 to create a policy association for 5G relay 510 that indicates the available network slices at 5G relay 510. PCF 538 responds to the request with policy association information like the SUPI, GPSI, PEI, and user location information for 5G relay 510. The policy association information includes a URSP container. The URSP container comprises URSP rules that control data routing to ones of UPFs 533-535 that compose the available network slices, the S-NSSAIs for the available network slices, and slice capabilities for each of the S-NSSAIs. PCF 538 subscribes to AMF 531 for event reporting like user location updates, registration state changes, communication failure events, and the like. AMF 531 creates a PCF subscription based on the policy association information and signals PCF 538 of the successful subscription creation.

AMF 531 selects SMF 532 to serve 5G relay 510 based on SMF selection data received from UDM 539. AMF 531 transfers a list of requested PDU sessions, a PDU session activation command, and 5G relay 510’s SUPI to SMF 532. SMF 532 selects one or more of UPFs 533-535 to support the PDU sessions for 5G relay 510. SMF 532 allocates IP addresses to 5G relay 510 for the requested PDU sessions and allocates a Tunnel End Point ID (TEID) for the session. SMF 532 transfers a session modification request that includes a session endpoint identifier, IP address, and TEID to the selected ones of UPFs 533-535 to setup the PDU session(s) for 5G relay 510. The selected ones of UPFs 533-535 set up a default bearer for 5G relay 510 that traverses 5G RAN 520. The default bearer is a link to carry IP packets for 5G relay 510’s PDU session(s).

SMF 532 notifies AMF 531 that the default bearer is set up. In response, AMF 531 registers 5G relay 510 for service on 5G communication network 500. AMF 531 generates a registration accept message that includes the URSP container, the allocated IP address for 5G relay 510, RAN ID, AMBR, Globally Unique AMF ID (GUAMI), PDU session data, S-NSSAI list, security data, and the like. AMF 531 transfers the registration accept message to 5G relay 510 over the NAS link that traverses 5G RAN 520. 5G relay 510 stores the URSP container in memory and may begin a PDU session on 5G communication network using the information included in the registration accept message.

Once 5G relay 510 has successfully registered with 5G communication network 500, 5G relay 510 may provide sidelink service to other user devices (e.g., UEs 501 and 502). For example, 5G relay 510 may comprise a fixed wireless access node may may provide Wifi coverage in the residence of the user(s) of UE 501 and UE 502. UEs 501 and 502 wirelessly attach to 5G relay 510 over a non-3GPP link like Wifi, Bluetooth. In some examples, UE 501 and UE 502 may attach to 5G relay 510 over a non-3GPP wired link like ethernet. In some examples, UE 501 and UE 502 may attach to 5G relay over a wireless 3GPP link like 5GNR, LTE, and the like. When UEs 501 and 502 are attached to 5G relay 510, they are referred to as tethered devices.

In response to the attachment of UEs 501 and 502, 5G relay 510 retrieves the URSP container that indicates the available network slices over 5G relay 510 from memory and provides the URSP container to UEs 501 and 502. UEs 501 and 502 launch user applications with various session requirements. The applications may be launched automatically (e.g., in response to device power up) or may be launched in response to user input. UEs 501 and 502 receive the URSP container and compare the slice capabilities for the S-NSSAIs included in the container to their device capabilities and application session requirements. For example, UE 501 may launch an Internet-of-Things (IoT) application with IoT session requirements, UE 501 may comprise IoT device capabilities, and the S-NSSAI for the mMTC slice may comprise capabilities tailored for IoT device traffic. UE 501 may compare its IoT session requirements and IoT device capabilities to the mMTC slice capabilities to support IoT traffic and select the S-NSSAI for the mMTC slice based on the comparison.

UEs 501 and 502 transfer registration requests to AMF 531 over 5G relay 510 and 5G RAN 520. The registration request indicates a registration type, 5G-GUTI, TAI, NSSAI requests for their selected network slices, UE capabilities, requests for PDU sessions for their launched applications, and the like. AMF 531 requests the identities of UEs 501 and 502 over 5G RAN 520 and 5G relay 510. UEs 501 and 502 indicate their SUCIs to AMF 531 over 5G relay 510 and 5G RAN 520. AMF 531 interfaces with AUSF 536 and UDM 539 to generate authentication challenges for UEs 501 and 502 as described above with respect to 5G relay 510. AMF 531 transfers the challenges to UEs 501 and 502 which respond with authentication results. AMF 531 matches the authentication results with expected results to authenticate UEs 501 and 502.

Responsive to the authentication, AMF 531 transfers context registration requests to UDM 539 and UDM 539 indicates successful UDM registration to AMF 531. In response, AMF 531 requests access and mobility subscription data, SMS selection subscription data, and UE context in SMF data from UDM 539. UDM 539 accesses the subscriber profile for 5G relay 510 and returns the requested data. The access and mobility subscription data, SMS selection subscription data, and/or UE context in SMF data indicate the allowed S-NSSAI for UEs 501 and 502. AMF 531 forms the context for UEs 501 and 502 using the retrieved information. The context defines the authorized services for UEs 501 and 502.

AMF 531 selects NSSF 537 to initiate network slice selection for UE 501. AMF 531 transfers a network slice selection get request to NSSF 537. The request indicates the list of allowed S-NSSAIs for UE 501 retrieved from UDM 539, the S-NSSAIs requested by UE 501 received in the registration request, and/or other slice selection information. NSSF 537 maps ones of the requested S-NSSAIs that correspond to the allowed S-NSSAIs to network slice instances in 5G data center 530. For example, NSSF 537 may map a requested and allowed S-NSSAI to the URLLC slice formed by UPF 535. NSSF 537 returns slide IDs for the mapped network slice instances to AMF 531. NSSF 537 may also return a list of SMFs that can support sessions on the mapped network slices.

AMF 531 transfers policy creation requests to PCF 538 to create policy associations for UEs 501 and 502. PCF 538 responds to the request with policy association information like the SUPI, GPSI, PEI, and user location information for UEs 501 and 502. PCF 538 subscribes to AMF 531 for event reporting like user location updates, registration state changes, communication failure events, and the like. AMF 531 creates PCF subscriptions based on the policy association information and signals PCF 538 of the successful subscription creation.

AMF 531 selects SMF 532 to serve UEs 501 and 502 based on SMF selection data received from UDM 539, the network policies received from PCF 538, and/or the network slice(s) selected by NSSF 537. AMF 531 transfers a list of requested PDU sessions, a PDU session activation command, and the SUPI for UEs 501 and 502 to SMF 532. SMF 532 receives the PDU session lists, session activation commands, and the SUPIs from AMF 531. SMF 532 selects one or more of UPFs 533-535 to support the PDU sessions based on the selected network slices. SMF 532 allocates IP addresses to UE 501 for the requested PDU sessions and allocates a TEID for the session. SMF 532 transfers a session modification request that includes a session endpoint identifier, IP address, and TEID to the selected ones of UPFs 533-535 to set up the PDU session(s) for UEs 501 and 502. The selected ones of UPFs 533-535 set up default bearers for UEs 501 and 502 that traverse 5G RAN 520 and 5G relay 510. The selected ones of UPFs 533-535 notify SMF 532 that bearer setup is complete.

SMF 532 notifies AMF 531 that the default bearer is set up. In response, AMF 531 registers UEs 501 and 502 for service on 5G communication network 500. AMF 531 generates registration accept messages that includes the allocated IP address for UE 501, RAN ID, AMBR, GUAMI, PDU session data, S-NSSAI list, security data, and the like. AMF 531 transfers the registration accept messages to UEs 501 and 502 over 5G RAN 520 and 5G relay 510. UEs 501 and 502 receive the registration accept messages and begin their respective PDU session(s). UEs 501 and 502 exchange user data with ones of UPFs 533-535 that correspond to their selected slices over 5G relay 510 and 5G RAN 520. UEs 501 and 502 route the data to the ones of UPFs 533-535 based on the URSP rules included in the URSP container. The ones of UPFs 533-535 that correspond to selected slices of UEs 501 and 502 exchange the user data with data network 540.

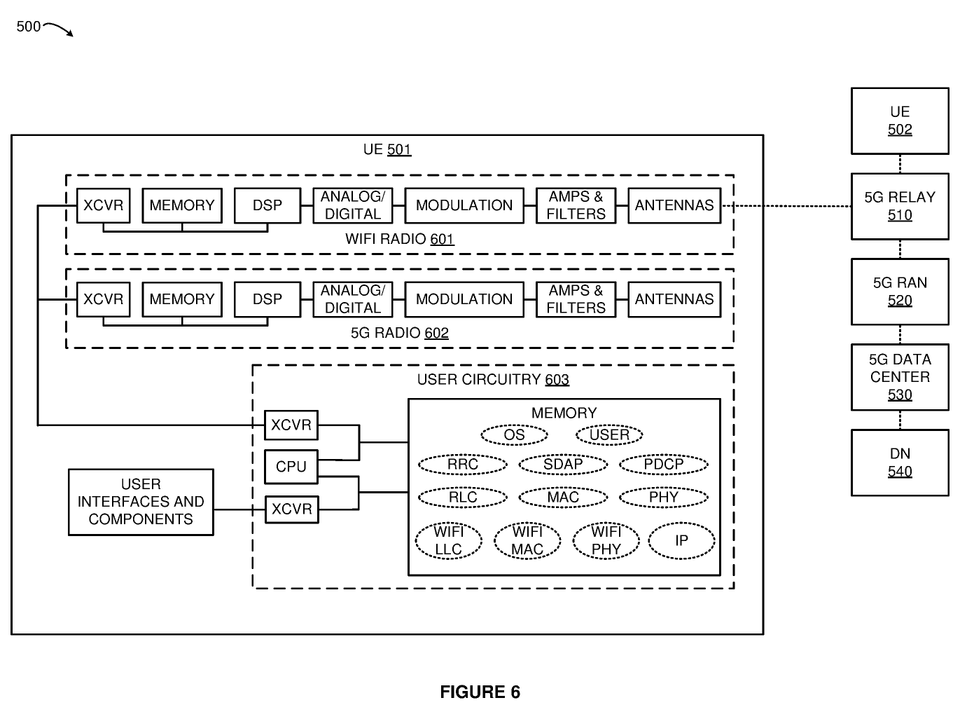

FIG. 6 illustrates UE 501 in 5G communication network 500. UE 501 comprises an example of user devices 101 and 102 illustrated in FIG. 1, although user devices 101 and 102 may differ. UE 502 comprises a similar architecture to UE 501. UE 501 comprises WiFi radio 601, 5G radio 602, and user circuitry 603. WiFi radio 601 comprises WiFi antennas, amplifiers, filters, modulation, analog-to-digital interfaces, Digital Signal Processers (DSP), memory, and transceivers (XCVRs) that are coupled over bus circuitry. 5G radio 602 comprises 5GNR antennas, amplifiers, filters, modulation, analog-to-digital interfaces, DSP, memory, and transceivers that are coupled over bus circuitry. User circuitry 603 comprises memory, CPU, user interfaces and components, and transceivers that are coupled over bus circuitry. The memory in user circuitry 603 stores an operating system (OS), user applications, 5GNR network applications for PHY, MAC, RLC, PDCP, SDAP, and RRC, and WiFi network applications for Logical Link Control (LLC), MAC, PHY, and IP. The antenna in WiFi radio 601 is wirelessly coupled to 5G relay 510 over a WiFi link. In some examples, the antenna in 5GNR radio 602 is wirelessly coupled to 5G RAN 520 over a 5GNR link. Transceivers in radios 601 and 602 are coupled to a transceiver in user circuitry 603. A transceiver in user circuitry 603 is typically coupled to user interfaces and components like displays, controllers, and memory. The CPU in user circuitry 603 executes the operating system and WiFi network applications to exchange data and signaling with 5G relay 510.

In WiFi radio 601, the antennas receive wireless signals from 5G relay 510 that transport downlink WiFi signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding WiFi symbols to user circuitry 603 over the transceivers. In user circuitry 603, the CPU executes the network applications to process the WiFi symbols and recover the downlink WiFi signaling and data. The WiFi network applications receive new uplink signaling and data from the user applications. The network applications process the uplink user signaling and the downlink WiFi signaling to generate new downlink user signaling and new uplink WiFi signaling. The network applications transfer the new downlink user signaling and data to the user applications. The network applications process the new uplink WiFi signaling and user data to generate corresponding uplink WiFi symbols that carry the uplink WiFi signaling and data.

In WiFi radio 601, the DSP processes the uplink WiFi symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless WiFi signals to 5G relay 510 that transport the uplink WiFi signaling and data.

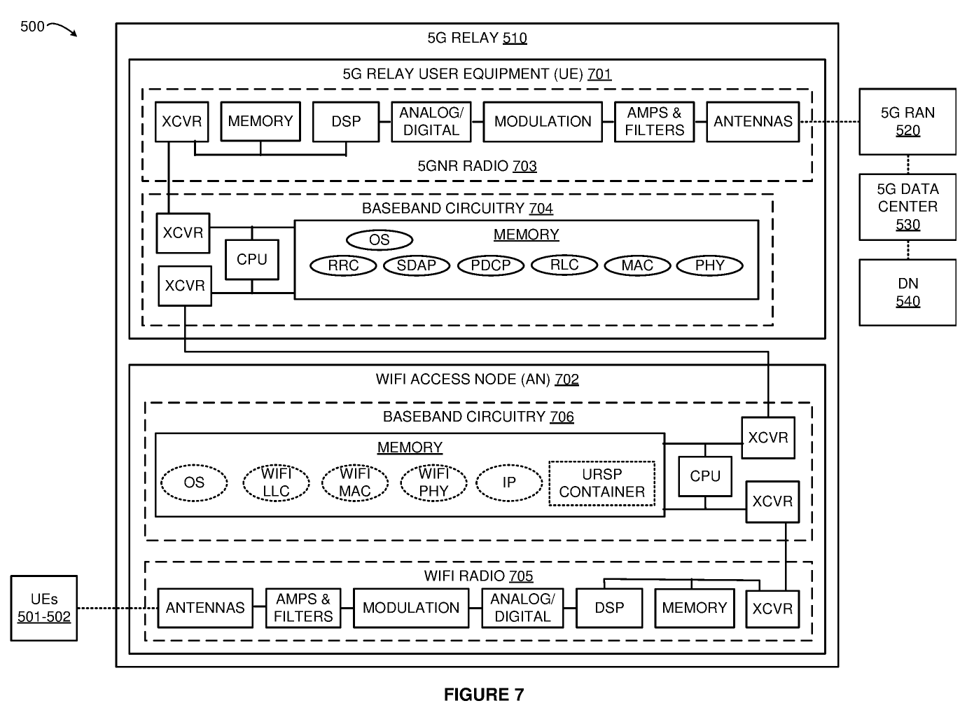

FIG. 7 illustrates 5G relay 510 in 5G communication network 500. 5G relay 510 comprises an example of relay 110 illustrated in FIG. 1, although relay 110 may differ. 5G relay 510 comprises 5G relay UE 701 and WiFi access node 702. 5G relay UE 701 comprises 5GNR radio 703 and baseband circuitry 704. Wifi access node 702 comprises WiFi radio 705 and baseband circuitry 706. Radios 703 and 705 comprise antennas, amplifiers, filters, modulation, analog-to-digital interfaces, DSP, memory, and transceivers (XCVRs) that are coupled over bus circuitry. Baseband circuitry 704 and 706 comprise memory, CPU, and transceivers that are coupled over bus circuitry. The memory in baseband circuitry 704 stores an operating system and 5GNR network applications for PHY, MAC, RLC, PDCP, SDAP, and RRC. The memory in baseband circuitry 706 stores an operating system, a URSP container, and WiFi network applications for IP, LLC, MAC, and PHY.

UEs 501 and 502 are wirelessly coupled to the antennas in WiFi radio 705 over wireless WiFi links. Transceivers in WiFi radio 705 are coupled to transceivers in baseband circuitry 706 over data links. Transceivers in baseband circuitry 706 are coupled transceivers in baseband circuitry 704. Transceivers in baseband circuitry 704 are coupled to transceivers in 5GNR radio 703. The antennas in 5GNR radio 703 are wirelessly coupled to 5G RAN 520 over 5GNR links. The CPUs in baseband circuitry 704 and 706 execute the operating systems, 5GNR network applications, and WiFi network applications to exchange WiFi signaling and data with UEs 501 and 502 and to exchange 5GNR signaling and data with 5G RAN 520.

In WiFi radio 705, the antennas receive wireless WiFi signals from UEs 501 and 502 that transport uplink WiFi signaling and data. The antennas transfer corresponding electrical uplink signals through duplexers to the amplifiers. The amplifiers boost the electrical uplink signals for filters which attenuate unwanted energy. Demodulators down-convert the filtered uplink signals from their carrier frequency. The analog/digital interfaces convert the demodulated analog uplink signals into digital uplink signals for the DSPs. The DSPs recover uplink WiFi symbols from the uplink digital signals. In baseband circuitry 706, the CPU executes the WiFi network applications to process the uplink WiFi symbols and recover the uplink WiFi signaling and data. The network applications transfer the uplink WiFi signaling and data to the 5GNR network applications in baseband circuitry 704.

In baseband circuitry 704, the network applications receive the uplink WiFi signaling and data from baseband circuitry 706. The network applications in baseband circuitry 704 process uplink WiFi signaling and data to generate new uplink 5GNR signaling and data. The 5GNR network applications in baseband circuitry 704 process the uplink 5GNR signaling and data to generate corresponding uplink 5GNR symbols that carry the signaling and data. In 5GNR radio 703, the DSP processes the uplink 5GNR symbols to generate corresponding digital signals for the analog-to-digital interfaces. The analog-to-digital interfaces convert the digital signals into analog signals for modulation. Modulation up-converts the analog signals to their carrier frequency. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to 5G RAN 520 that transport the uplink 5GNR signaling and data.

In 5GNR radio 703, the antennas receive wireless 5GNR signals from 5G RAN 520 that transport downlink 5GNR signaling and data. The antennas transfer corresponding electrical downlink signals through duplexers to the amplifiers. The amplifiers boost the electrical downlink signals for filters which attenuate unwanted energy. Demodulators down-convert the filtered downlink signals from their carrier frequency. The analog/digital interfaces convert the demodulated analog downlink signals into digital downlink signals for the DSPs. The DSPs recover downlink 5GNR symbols from the downlink digital signals. In baseband circuitry 704, the CPU executes the network applications to process the downlink 5GNR symbols and recover the downlink 5GNR signaling and data. The network applications process the downlink 5GNR signaling to generate the downlink WiFi signaling and data. The network applications transfer the downlink WiFi signaling to the WiFi network applications in baseband circuitry 706.

In baseband circuitry 706, the WiFi network applications receive the downlink WiFi signaling and data from baseband circuitry 704. The WiFi network applications process the downlink WiFi signaling and data to generate corresponding downlink WiFi symbols that carry the WiFi signaling and data. In WiFi radio 705, the DSP processes the downlink WiFi symbols to generate corresponding digital signals for the analog-to-digital interfaces. The analog-to-digital interfaces convert the digital signals into analog signals for modulation. Modulation up-converts the analog signals to their carrier frequency. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UEs 501 and 502 that transport the downlink WiFi signaling and data.

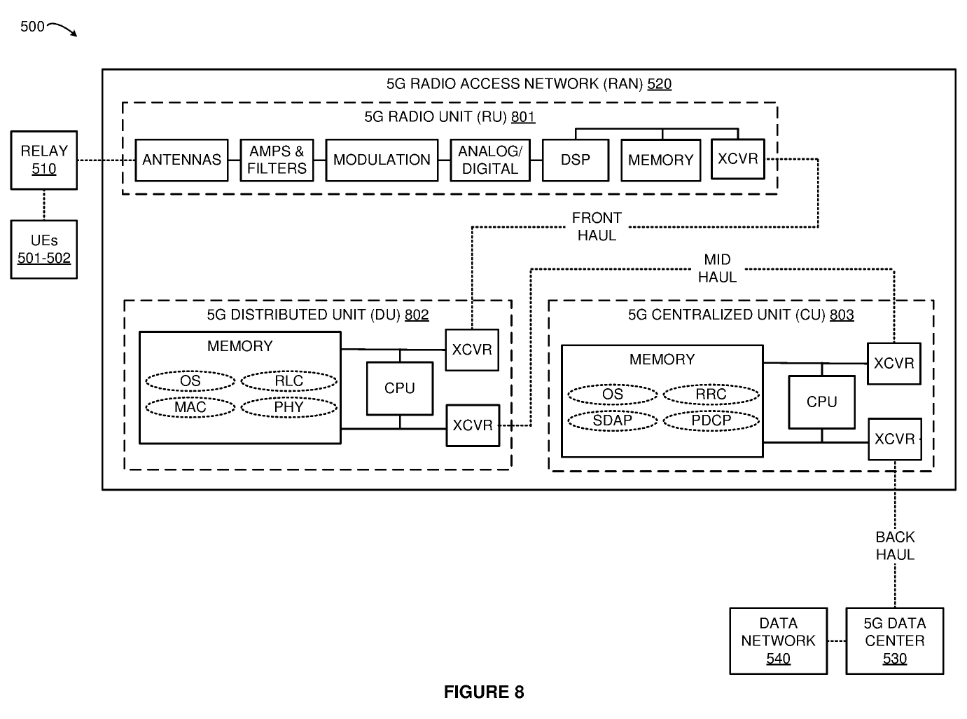

FIG. 8 illustrates 5G RAN 520 in 5G communication network 500. 5G RAN 520 comprises an example of access network 120 illustrated in FIG. 1, although access network 120 may differ. 5G RU 801 comprises 5GNR antennas, amplifiers, filters, modulation, analog-to-digital interfaces, DSP, memory, and transceivers (XCVRs) that are coupled over bus circuitry. 5G relay 510 is wirelessly coupled to antennas in 5G RU 801 over 5GNR links. Transceivers in 5G RU 801 are coupled to transceivers in 5G DU 802 over fronthaul links like enhanced Common Public Radio Interface (eCPRI). The DSPs in 5G RU 801 executes their operating systems and radio applications to exchange 5GNR signals with 5G relay 510 and to exchange 5GNR data with 5G DU 802.

For the uplink, the antennas in 5G RU 801 receive wireless signals from 5G relay 510 that transport uplink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to 5G DU 802 over the transceivers.

For the downlink, the DSPs receive downlink 5GNR symbols from 5G DU 802. The DSPs process the downlink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to 5G relay 510 that transport the downlink 5GNR signaling and data.

5G DU 802 comprises memory, CPU, and transceivers that are coupled over bus circuitry. The memory in 5G DU 802 stores operating systems and 5GNR network applications like PHY, MAC, and RLC. 5G CU 803 comprises memory, CPU, and transceivers that are coupled over bus circuitry. The memory in 5G CU 803 stores an operating system and 5GNR network applications like PDCP, SDAP, and RRC. Transceivers in 5G DU 802 are coupled to transceivers in 5G RU 801 over front-haul links. Transceivers in 5G DU 802 are coupled to transceivers in 5G CU 803 over mid-haul links. A transceiver in 5G CU 803 is coupled to 5G data center 530 over backhaul links.

RRC functions comprise authentication, security, handover control, status reporting, Quality-of-Service (QoS), network broadcasts and pages, and network selection. SDAP functions comprise QoS marking and flow control. PDCP functions comprise security ciphering, header compression and decompression, sequence numbering and re-sequencing, de-duplication. RLC functions comprise Automatic Repeat Request (ARQ), sequence numbering and resequencing, segmentation and resegmentation. Wifi LLC functions may be similar to the RLC functions. MAC functions comprise buffer status, power control, channel quality, Hybrid ARQ (HARQ), user identification, random access, user scheduling, and QoS. PHY functions comprise packet formation/deformation, windowing/de-windowing, guard-insertion/guard-deletion, parsing/de-parsing, control insertion/removal, interleaving/de-interleaving, Forward Error Correction (FEC) encoding/decoding, channel coding/decoding, channel estimation/equalization, and rate matching/de-matching, scrambling/descrambling, modulation mapping/de-mapping, layer mapping/de-mapping, precoding, Resource Element (RE) mapping/de-mapping, Fast Fourier Transforms (FFTs)/Inverse FFTs (IFFTs), and Discrete Fourier Transforms (DFTs)/Inverse DFTs (IDFTs).

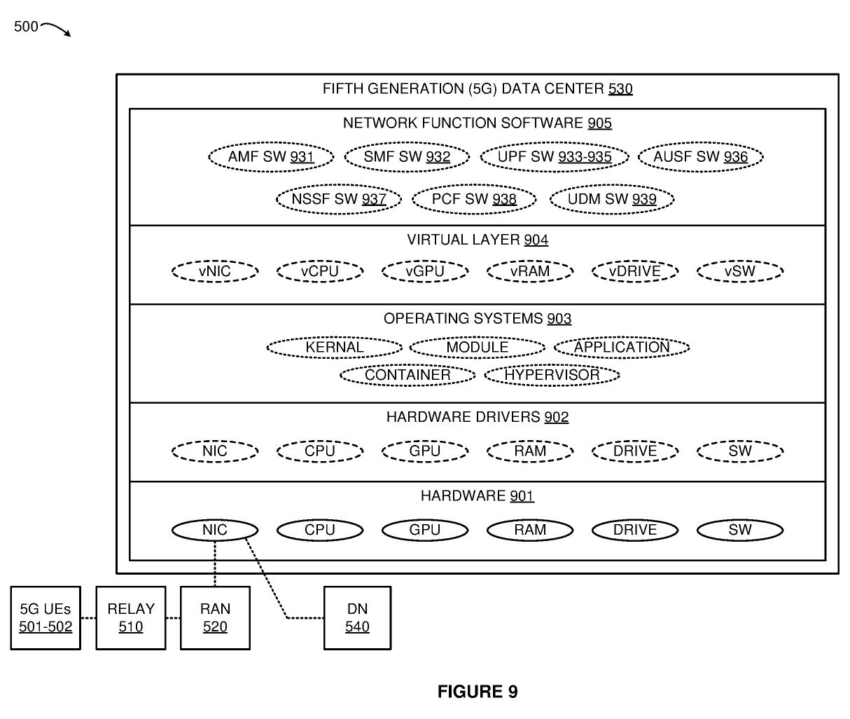

FIG. 9 illustrates 5G data center 530 in 5G communication network 500. 5G data center 530 comprises an example of core network 130 illustrated in FIG. 1, although core network 130 may differ. 5G data center 530 typically comprises a virtualized computing architecture like NFVI, but may comprise another computing architecture like a cloud computing network, a hybrid cloud network, and the like. 5G data center 530 comprises hardware 901, hardware drivers 902, operating systems 903, virtual layer 904, and network function software 905. Hardware 901 comprises Network Interface Cards (NICs), CPU, GPU, RAM, Flash/Disk Drives (DRIVE), and Data Switches (SW). Hardware drivers 902 comprise software that is resident in the NIC, CPU, GPU, RAM, DRIVE, and SW. Operating systems 903 comprise kernels, modules, applications, containers, hypervisors, and the like. Virtual layer 904 comprises vNIC, vCPU, vGPU, vRAM, vDRIVE, and vSW. Network function software 905 comprises AMF Software (SW) 931, SMF SW 932, UPF SW 933-935, AUSF SW 936, NSSF SW 937, PCF SW 938, and UDM SW 939. Additional network function software for network functions like UDR, CHF, HLR, HSS, NRF, SMSF, NEF, AF, EIR, and SCP is typically present but is omitted for clarity. 5G data center 530 may be located at a single site or be distributed across multiple geographic locations. The NIC in hardware 901 is coupled to 5G RAN 520, data network 540, and to external systems (not illustrated). Hardware 901 executes hardware drivers 902, operating systems 903, virtual layer 904, and network function software 905 to form AMF 531, SMF 532, UPFs 533-535, AUSF 536, NSSF 537, PCF 538, and UDM 539.

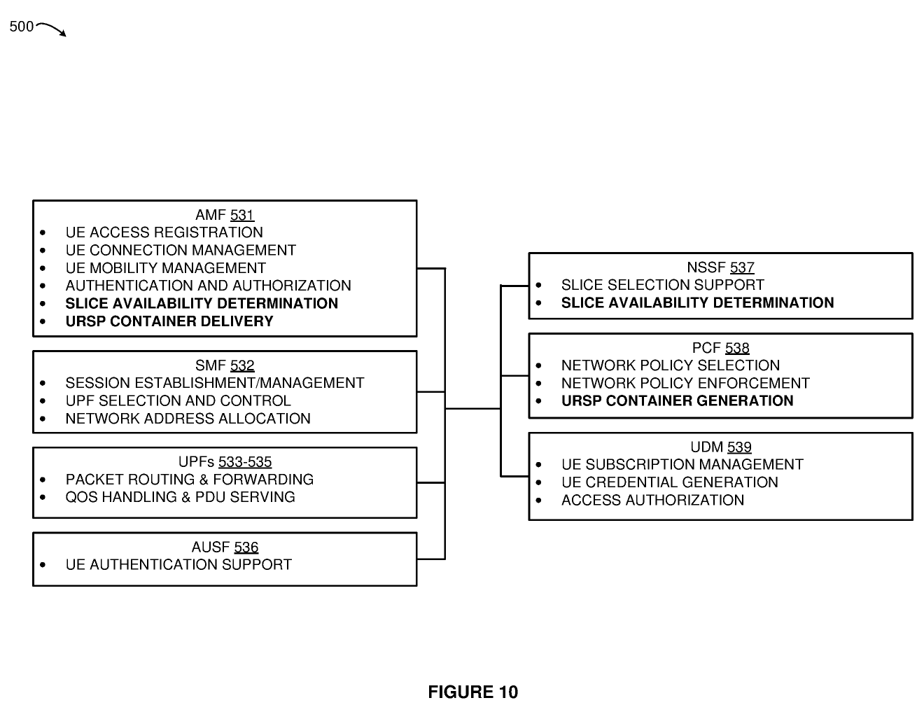

FIG. 10 further illustrates 5G data center 530 in 5G communication network 500. AMF 531 capabilities comprise UE access registration, UE connection management, UE mobility management, UE authentication, UE authorization, slice availability determination, and URSP container delivery. SMF 532 capabilities comprise session establishment, session management, UPF selection, UPF control, network address allocation, and encrypted data path control. UPFs 533-535 capabilities comprise pack routing, packet forwarding, QoS handling, and PDU serving. AUSF 536 capabilities comprise UE authentication support. NSSF 537 capabilities comprise slice selection support and slice availability determination. PCF 538 capabilities comprise network policy selection, network policy enforcement, and URSP container creation. UDM 539 capabilities comprise UE subscription management, UE credential generation, and UE access authorization.

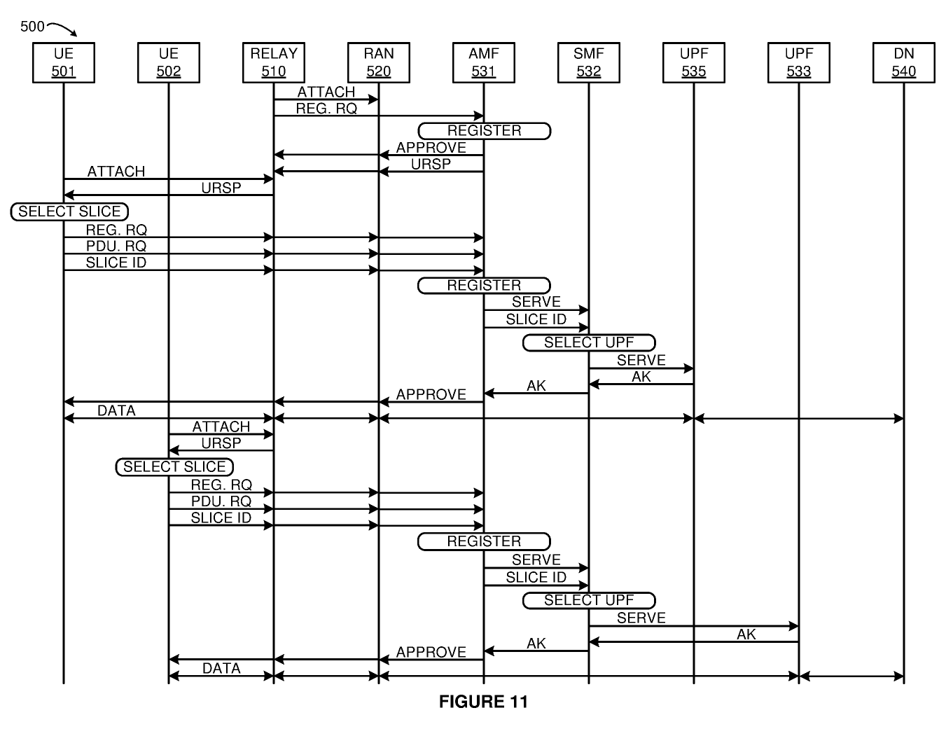

FIG. 11 illustrates an exemplary operation of 5G communication network 500 to serve network slices to UEs over a 5G relay. The exemplary operation comprises an example of processes 200, 300, and 400 illustrated in FIGS. 2-4, however processes 200, 300, and 400 may differ. The exemplary operation may vary in other examples. In some examples, 5G relay 510 wirelessly attaches to 5G RAN 520 over a 5GNR link. 5G relay 510 transfers a registration request to AMF 531 over 5G RAN 520. The registration request indicates the TAI or other location information for 5G relay 510. In response to the registration request, AMF 531 interfaces with AUSF 536 and UDM 539 to authenticate 5G relay 510. Responsive to the authentication, AMF 531 retrieves context for 5G relay 510 from UDM 539. The context comprises access and mobility subscription data, SMS selection subscription data, and/or UE context in SMF data. The context indicates 5G relay 510 comprises a relay device with sidelink capabilities. AMF 531 forms the context for 5G relay 510 using the retrieved information.

AMF 531 determines 5G relay 510 comprises sidelink capabilities based on the context for 5G relay 510. AMF 531 transfers a slice availability request that indicates the TAI of 5G relay 510 to NSSF 537 to determine the wireless network slices available over 5G relay 510. NSSF 537 hosts a data structure that correlates network slice availability with TAIs in 5G communication network 500. NSSF 537 compares the TAI for 5G relay 510 to the data structure to and determines that the eMBB slice, mMTC slice, and URLLC slice are available at 5G relay 510. NSSF 537 indicates the S-NSSAIs for the eMBB slice, mMTC slice, and the URLLC slice to AMF 531. AMF 531 requests URSP rules based on the available S-NSSAIs from PCF 538. PCF 538 provides a URSP container to AMF 531. The URSP container comprises URSP rules that control data routing to ones of UPFs 533-535 that compose the available network slices, the S-NSSAIs for the available network slices, and slice capabilities for each of the S-NSSAIs.

AMF 531 directs SMF 532 to serve 5G relay 510. SMF 532 directs one of UPFs 533-535 to support PDU sessions for 5G relay 510 and notifies AMF 531 that the default bearer for 5G relay 510 is established. In response, AMF 531 registers 5G relay 510 for service on 5G communication network 500. AMF 531 transfers a registration accept message and the URSP container to 5G relay 510 over 5G RAN 520. 5G relay 510 stores the URSP container in memory and may begin a PDU session on 5G communication network using the information included in the registration accept message.

UE 501 attaches to 5G relay 510 over a WiFi link. In response, 5G relay 510 retrieves the URSP container that indicates the available network slices over 5G relay 510 from memory and provides the URSP container to UE 501. UE 501 comprises low-latency capabilities and launches an online gaming application with low-latency requirements. UE 501 accesses the URSP container and examines the slice capabilities of the S-NSSAIs included in the container. UE 501 determines the S-NSSAI for the URLLC slice can support low-latency PDU sessions. In response, UE 501 selects the S-NSSAI for the URLLC slice based on the slice’s low-latency capabilities, UE 501’s low-latency capabilities, and the low-latency session requirements for the online gaming application.

UE 501 generates a registration request that includes a PDU session request for the online gaming application and requests the S-NSSAI for the URLLC slice. UE 501 transfers the registration request to AMF 531 over 5G relay 510 and 5G RAN 520. AMF 531 interfaces with AUSF 536 and UDM 539 to authenticate UE 501. Responsive to authentication, AMF 531 interfaces with UDM 539 to generate context for UE 501. UDM 539 provides access and mobility subscription data, SMS selection subscription data, and UE context in SMF data for UE 501 to AMF 531. AMF 531 forms the context for UE 501 using the retrieved information. The context indicates UE 501 is authorized to use URLLC slices.

AMF 531 selects NSSF 537 to select a network slice for UE 501. AMF 531 indicates allowed S-NSSAIs for UE 501 as specified by the context and the S-NSSAI for the URLLC slice requested by UE 501 in the registration request. NSSF 537 determines the S-NSSAI for the URLLC slice is an allowed S-NSSAI. NSSF 537 maps the S-NSSAI for the URLLC slice to a URLLC network slice instance in 5G data center 530. NSSF 537 returns the slide ID for the URLLC network slice instance to AMF 531.

AMF 531 selects SMF 532 to serve UE 501 based on the context and the selected network slice for UE 501. AMF 531 directs SMF 532 to establish the requested PDU session for UE 501 and indicates the slice ID for the URLLC slice to SMF 532. SMF 532 selects UPF 535 to support the PDU sessions based on the slice ID. SMF 532 allocates addresses for the session and transfers a session establishment request to UPF 535 to set up the PDU session for UE 501. UPF 535 sets up a default bearer for UE 501 for the PDU session. UPF 535 transfers an acknowledgement (AKs) to SMF 532 that bearer setup is complete.

SMF 532 notifies AMF 531 that the default bearer is set up. In response, AMF 531 registers UE 501 for service on 5G communication network 500. AMF 531 transfers a registration accept message to UE 501 over 5G RAN 520 and 5G relay 510. UE 501 begins the low-latency PDU session on the URLLC slice over 5G relay 510. UE 501 exchanges user data with UPF 535 in the URLLC slice over 5G relay 510 and 5G RAN 520. UE 501 routes the data to UPF 535 based on the URSP rules included in the URSP container. UPF 535 exchanges the user data with data network 540.

Contemporaneously, UE 502 attaches to 5G relay 510 over a WiFi link. In response, 5G relay 510 retrieves the URSP container that indicates the available network slices over 5G relay 510 from memory and provides the URSP container to UE 502. UE 502 comprises enhanced data rate capabilities and launches a media streaming application with enhanced data rate requirements. UE 502 accesses the URSP container and examines the slice capabilities of the S-NSSAIs included in the container. UE 502 determines the S-NSSAI for the eMBB slice can support enhanced data rate PDU sessions. In response, UE 502 selects the S-NSSAI for the eMBB slice based on the slice’s enhanced data rate capabilities, UE 502’s enhanced data rate capabilities, and the enhanced data rate session requirements for the media streaming application.

UE 502 generates a registration request that includes a PDU session request for the media streaming application and requests the S-NSSAI for the eMBB slice. UE 502 transfers the registration request to AMF 531 over 5G relay 510 and 5G RAN 520. AMF 531 interfaces with AUSF 536 and UDM 539 to authenticate UE 502. Responsive to authentication, AMF 531 interfaces with UDM 539 to generate context for UE 502. UDM 539 provides access and mobility subscription data, SMS selection subscription data, and UE context in SMF data for UE 502 to AMF 531. AMF 531 forms the context for UE 502 using the retrieved information. The context indicates UE 502 is authorized to use eMBB slices.

AMF 531 selects NSSF 537 to select a network slice for UE 502. AMF 531 indicates allowed S-NSSAIs for UE 502 as specified by the context and the S-NSSAI for the eMBB slice requested by UE 502 in the registration request. NSSF 537 determines the S-NSSAI for the eMBB slice is an allowed S-NSSAI. NSSF 537 maps the S-NSSAI for the eMBB slice to an eMBB network slice instance in 5G data center 530. NSSF 537 returns the slide ID for the eMBB network slice instance to AMF 531.

AMF 531 selects SMF 532 to serve UE 502 based on the context and the selected network slice for UE 502. AMF 531 directs SMF 532 to establish the requested PDU session for UE 502 and indicates the slice ID for the eMBB slice to SMF 532. SMF 532 selects UPF 533 to support the PDU sessions based on the slice ID. SMF 532 allocates addresses for the session and transfers a session establishment request to UPF 533 to set up the PDU session for UE 502. UPF 533 sets up a default bearer for UE 502 for the PDU session. UPF 533 notifies SMF 532 that bearer setup is complete.

SMF 532 notifies AMF 531 that the default bearer is set up. In response, AMF 531 registers UE 502 for service on 5G communication network 500. AMF 531 transfers a registration accept message to UE 502 over 5G RAN 520 and 5G relay 510. UE 502 begins the enhanced data rate session on the eMBB slice over 5G relay 510. UE 502 exchanges user data with UPF 533 in the eMBB slice over 5G relay 510 and 5G RAN 520. UE 502 routes the data to UPF 533 based on the URSP rules included in the URSP container. UPF 533 that exchanges the user data with data network 540.

The wireless data network circuitry described above comprises computer hardware and software that form special-purpose network circuitry to serve network slices to user devices over a relay. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to serve network slices to user devices over a relay.

Although the descriptions provided herein may be in the context of certain radio access technologies, networks, and network topologies, such as 5GNR mobile communications, the proposed concepts, schemes, and any variations thereof may be implemented in, for and by other types of radio access technologies, networks, and network topologies. Such radio access technologies, networks, and network topologies may include, for example and without limitation, LTE, Internet-of-Things (IoT), NB-IoT, Vehicle-to-Everything (V2X), fixed wireless internet, and Non-Terrestrial Network (NTN) communications. Thus, the scope of the disclosure is not limited to the examples described herein.

The above description and associated figures teach the best mode of the invention. For the purpose of teaching inventive principles, some conventional aspects of the best mode may be simplified or omitted. The following claims specify the scope of the invention. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described above, nor the best mode, but only by the claims and their equivalents.

What is claimed is:

1. A method comprising:
registering, by a relay, with a network controller in a communication network over an access network;
indicating, by the network controller, available network slices to the relay over the access network;
indicating, by the relay, the available network slices to a user device attached to the relay;
receiving, by the network controller, a registration request from the user device for service on the communication network that includes a session request and that indicates a selected network slice of the available network slices indicated by the relay;
registering, by the network controller, the user device for the service on the communication network;
directing, by the network controller, a user plane in the communication network and of the selected network slice to serve the user device; and
exchanging, by the user plane, user data with the user device over the access network and the relay.

2. The method of claim 1 further comprising:
indicating, by the relay, the available network slices to another user device attached to the relay;
receiving, by the network controller, another registration request from the other user device that includes another session request and that indicates another selected network slice of the available network slices indicated by the relay;
registering, by the network controller, the other user device on the communication network;
directing, by the network controller, another user plane in the communication network and of the other selected network slice to serve the other user device; and
exchanging, by the other user plane, other user data with the other user device over the access network and the relay.

3. The method of claim 1 wherein:
indicating, by the network controller, the available network slices to the relay over the access network comprises transferring, by the network controller, a User Equipment Route Selection Policy (URSP) container that includes slice Identifiers (IDs) for the available network slices and capabilities of the slice IDs to the relay; and
indicating, by the relay, the available network slices to the user device comprises transferring, by the relay, the URSP container to the user device.

4. The method of claim 3 wherein the user device selects a slice ID from the slice IDs included in the URSP container based on the capabilities of the slice IDs, session requirements of the user device, and device capabilities of the user device.

5. The method of claim 4 wherein receiving, by the network controller, the registration request from the user device for the service on the communication network comprises receiving, by the network controller, the registration request that includes a Protocol Data Unit (PDU) session request and the slice ID of the selected network slice.

6. The method of claim 1 wherein:
registering, by the relay, with the network controller in the communication network over the access network comprises providing relay location information to the network controller over the access network; and further comprising:
identifying, by the network controller, the available network slices based on the relay location information.

7. The method of claim 6 wherein the relay location information comprises a Tracking Area Identifier (TAI) associated with the relay.

8. The method of claim 1 wherein:
the available network slices comprise two of more of an Enhanced Mobile Broadband (eMBB) slice, an Ultra-Reliable Low-Latency Communications (URLLC) slice, a Massive Machine-Type Communications (mMTC) slice, a Vehicle To Everything (V2X) slice, a Fixed Wireless Access (FWA) slice, and a private network slice; and
the network slice comprises one of the eMBB slice, the URLLC slice, the mMTC slice, the V2X slice, the FWA slice, or the private network slice.

9. The method of claim 1 wherein the network controller comprises one or more of an Access and Mobility Management Function (AMF) or a Session Management Function (SMF).

10. The method of claim 1 wherein the user plane comprises a User Plane Function (UPF).

11. The method of claim 1 wherein the relay comprises at least one of a WiFi hotspot or a Fifth Generation (5G) router.

12. A system comprising:
a relay configured to register with a network controller in a communication network over an access network;
the network controller configured to indicate available network slices to the relay over the access network;
the relay further configured to indicate the available network slices to a user device attached to the relay;
the network controller further configured to receive a registration request from the user device for service on the communication network that includes a session request and that indicates a selected network slice of the available network slices indicated by the relay;
the network controller further configured to register the user device for the service on the communication network;
the network controller further configured to direct a user plane in the communication network and of the network slice to serve the user device; and
the user plane configured to exchange user data with the user device over the access network and the relay.

13. The system of claim 12 further comprising another user plane; and wherein:
the relay is further configured to indicate the available network slices to another user device attached to the relay;
the network controller is further configured to receive another registration request from the other user device that includes another session request and that indicates another selected network slice of the available network slices indicated by the relay;
the network controller is further configured to register the other user device on the communication network;
the network controller is further configured to direct the other user plane in the communication network and of the other selected network slice to serve the other user device; and
the other user plane is configured to exchange other user data with the other user device over the access network and the relay.

14. The system of claim 12 wherein:
the network controller is further configured to transfer a User Equipment Route Selection Policy (URSP) container that includes slice Identifiers (IDs) for the available network slices and capabilities of the slice IDs to the relay; and
the relay is further configured to transfer the URSP container to the user device.

15. The system of claim 14 wherein:
the user device selects a slice ID from the slice IDs included in the URSP container based on the capabilities of the slice IDs, session requirements of the user device, and device capabilities of the user device; and
the network controller is further configured to receive the registration request that includes a Protocol Data Unit (PDU) session request and the slice ID of the selected network slice.

16. The system of claim 12 wherein:
the relay is further configured to provide relay location information to the network controller over the access network; and
the network controller is further configured to identify the available network slices based on the relay location information.

17. The system of claim 16 wherein the relay location information comprises a Tracking Area Identifier (TAI) associated with the relay.

18. The system of claim 12 wherein:
the available network slices comprise two of more of an Enhanced Mobile Broadband (eMBB) slice, an Ultra-Reliable Low-Latency Communications (URLLC) slice, a Massive Machine-Type Communications (mMTC) slice, a Vehicle To Everything (V2X) slice, a Fixed Wireless Access (FWA) slice, and a private network slice; and
the network slice comprises one of the eMBB slice, the URLLC slice, the mMTC slice, the V2X slice, the FWA slice, or the private network slice.

19. The system of claim 12 wherein:
the network controller comprises one or more of an Access and Mobility Management Function (AMF) and a Session Management Function (SMF);
the user plane comprises a User Plane Function (UPF); and
the relay comprises at least one of a WiFi hotspot or a Fifth Generation (5G) router.

20. One or more non-transitory computer readable storage media having program instructions stored thereon, wherein the program instruction, when executed by a computing system, direct the computing system to perform operations, the operations comprising:
directing a radio in a wireless relay to transfer a registration request to a network controller in a communication network over an access network wherein the network controller registers the relay with the communication network;
controlling the radio to receive a registration accept message and a User Equipment Route Selection Policy (URSP) container from the network controller over the access network wherein the URSP container indicates slice Identifiers (IDs) of available network slices on the communication network;
controlling the radio to receive an attachment request from a user device;
approving the attachment request from the user device; and
directing the radio to transfer the URSP container to the user device wherein the user device selects one or more network slices based on the slice IDs indicated in the URSP container.
